(19) United States
(12) Patent Application Publication
(10) Pub. No.: US 2022/0222545 A1
(43) Pub. Date: Jul. 14, 2022

(54) GENERATION METHOD, NON-TRANSITORY COMPUTER-READABLE STORAGE MEDIUM, AND INFORMATION PROCESSING DEVICE

(71) Applicant: FUJITSU LIMITED, Kawasaki-shi (JP)

(72) Inventor: Yasuto Yokota, Kawasaki (JP)

(73) Assignee: FUJITSU LIMITED, Kawasaki-shi (JP)

(21) Appl. No.: 17/708,145

(22) Filed: Mar. 30, 2022

Related U.S. Application Data
(63) Continuation of application No. PCT/JP2019/041807, filed on Oct. 24, 2019.

(51) Int. Cl. G06N 5/02

(52) U.S. Cl. CPC G06N 5/022

(57) ABSTRACT

A generation method performed by a computer, the generation method includes classifying a plurality of pieces of teacher data into each cycle according to a condition that is preset, and generating each detection model, which corresponds to each cycle, that detects a change in an output result of a machine learning model for each cycle by using teacher data that belongs to each cycle.

### CROSS-REFERENCE TO RELATED APPLICATION

This application is a continuation application of International Application PCT/JP2019/041807 filed on Oct. 24, 2019 and designated the U.S., the entire contents of which are incorporated herein by reference.

### FIELD

The embodiments discussed herein are related to a generation method, a generation program, and an information processing device.

### BACKGROUND

A machine learning model (hereinafter, may be simply referred to as “model”) has been increasingly introduced into an information system used in companies or the like, for data determination and classification functions, or the like. Because the machine learning model performs determination and classification as in teacher data learned when the system is developed, if a tendency (data distribution) of input data changes during a system operation, accuracy of the machine learning model deteriorates.

Generally, in order to detect the model accuracy deterioration during the system operation, a method is used for periodically and manually calculating a correct answer rate by confirming whether or not an output result of the model is correct or wrong by humans and detecting accuracy deterioration from decrease in the correct answer rate.

In recent years, as a technique for automatically detecting the accuracy deterioration of the machine learning model during the system operation, a T² statistics amount (Hotelling's T-square) has been known. For example, main components of an input data group and a normal data (training data) group are analyzed, and a T² statistics amount of input data that is a sum of squares of distances from an origin to respective standardized main components is calculated. Then, a change in a ratio of abnormal value data is detected based on a distribution of the T² statistics amount of the input data group, and the accuracy deterioration of the model is automatically detected.

A. Shabbak and H. Midi, “An Improvement of the Hotelling T² Statistic in Monitoring Multivariate Quality Characteristics”, Mathematical Problems in Engineering, pp. 1 to 15, 2012 is disclosed as related art.

### SUMMARY

According to an aspect of the embodiments, a generation method performed by a computer, the generation method includes: classifying a plurality of pieces of teacher data into each cycle according to a condition that is preset; and generating each detection model, which corresponds to each cycle, that detects a change in an output result of a machine learning model for each cycle by using teacher data that belongs to each cycle.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for explaining an accuracy deterioration detection device according to a first embodiment;

FIG. 2 is a diagram for explaining accuracy deterioration;

FIG. 3 is a diagram for explaining an inspector model according to the first embodiment;

FIG. 4 is a functional block diagram illustrating a functional structure of the accuracy deterioration detection device according to the first embodiment;

FIG. 5 is a diagram illustrating an example of information stored in a teacher data DB;

FIG. 6 is a diagram illustrating an example of information stored in an input data DB;

FIG. 7 is a diagram for explaining detection of the accuracy deterioration;

FIG. 8 is a diagram for explaining real-time display of an accuracy state;

FIG. 9 is a flowchart illustrating a flow of processing according to the first embodiment;

FIG. 10 is a diagram for explaining effects;

FIG. 11 is a diagram for explaining a specific example of teacher data;

FIG. 12 is a diagram for explaining an execution result of accuracy deterioration detection;

FIG. 13 is a diagram for explaining erroneous detection of data that periodically changes;

FIG. 14 is a functional block diagram illustrating a functional structure of an accuracy deterioration detection device according to a second embodiment;

FIG. 15 is a diagram for explaining learning of an inspector model according to the second embodiment;

FIG. 16 is a diagram for explaining detection of accuracy deterioration according to the second embodiment;

FIG. 17 is a flowchart illustrating a flow of processing according to the second embodiment;

FIG. 18 is a diagram for explaining effects of the second embodiment;

FIG. 19 is a diagram for explaining a specific example of the second embodiment;

FIG. 20 is a functional block diagram illustrating a functional structure of an accuracy deterioration detection device according to a third embodiment; and

FIG. 21 is a diagram for explaining a hardware structure example.

### DESCRIPTION OF EMBODIMENTS

In the rerated art, in order to monitor the accuracy of the model during the system operation in real time, the T² statistics amount is manually calculated and confirmed. Therefore, a processing load is high, and it is realistically difficult to periodically perform monitoring.

In one aspect, an object is to provide a generation method, a generation program, and an information processing device that can monitor accuracy of a model during a system operation in real time.

Hereinafter, embodiments of a generation method, a generation program, and an information processing device according to the present disclosure will be described in detail with reference to the drawings. Note that the embodiments do not limit the present disclosure. Furthermore, each of the embodiments may be appropriately combined within a range without inconsistency.

### First Embodiment

[Explanation of Accuracy Deterioration Detection Device]

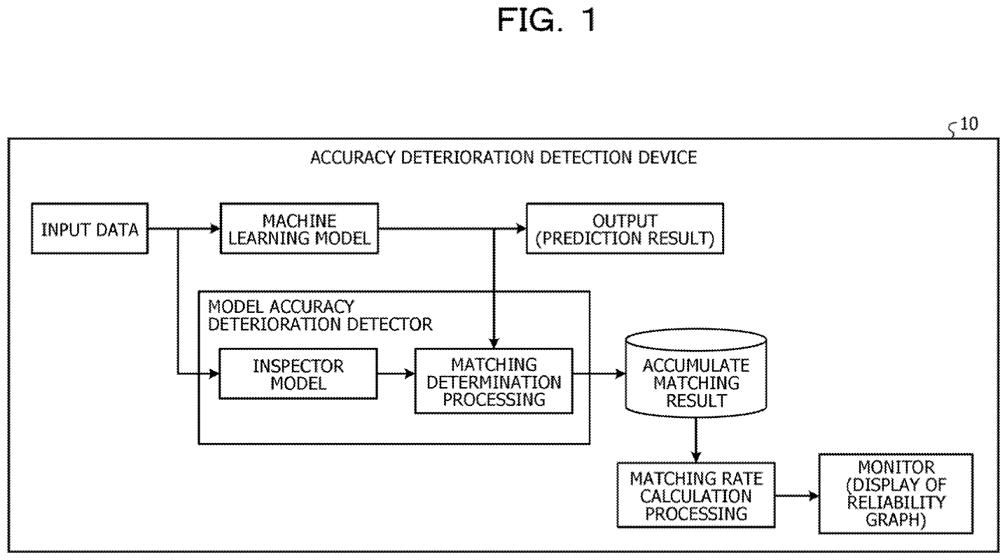

FIG. 1 is a diagram for explaining an accuracy deterioration detection device 10 according to a first embodiment. The accuracy deterioration detection device 10 illustrated in FIG. 1 is an example of a computer device that determines (classify) input data using a learned machine learning model (hereinafter, may be simply referred to as “model”) and monitors accuracy of the machine learning model and displays an accuracy state in real time.

For example, the machine learning model is an image classifier that is learned using teacher data with an explanatory variable as image data and an objective variable as a clothing name at the time of learning and outputs a determination result such as “shirt” when the image data is input as the input data at the time of an operation. That is, for example, the machine learning model is an example of an image classifier that classifies high-dimensional data or performs multi-class classification.

Here, because a machine learning model learned through machine learning, deep learning, or the like is learned on the basis of teacher data in which training data and labeling are combined, the machine learning model functions only in a range included in the teacher data. On the other hand, although it is assumed that data that is the same type as that at the time of learning be input to the machine learning model after operation, there is a case where a state of the input data changes in reality and the machine learning model does not properly function. In other words, for example, “model accuracy deterioration” occurs.

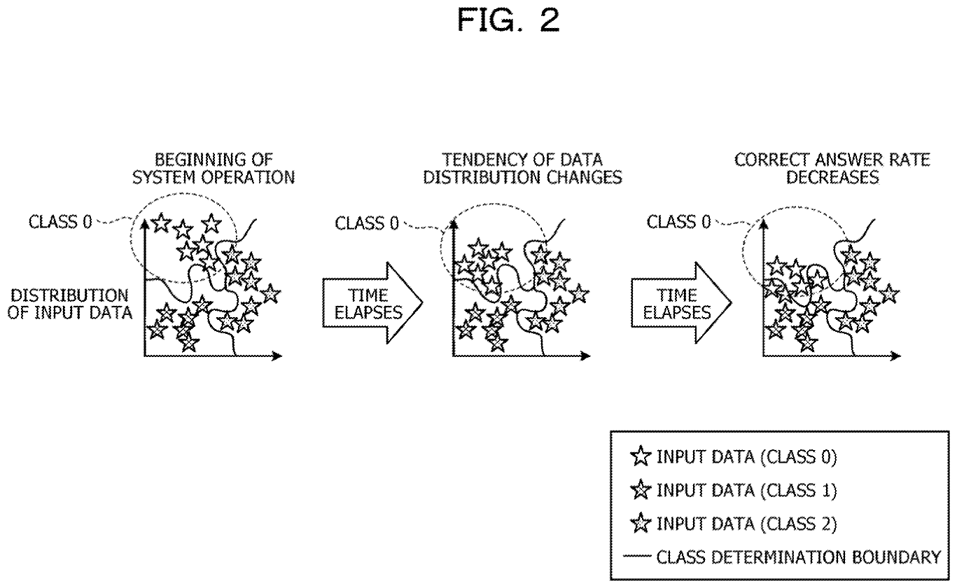

FIG. 2 is a diagram for explaining the accuracy deterioration. FIG. 2 illustrates information that is organized by excluding unnecessary data of the input data and illustrates a feature amount space in which the machine learning model classifies the input data that has been input. FIG. 2 illustrates a feature amount space classified into a class 0, a class 1, and a class 2.

As illustrated in FIG. 2, at the initial time of a system operation (at the time when learning is completed), all pieces of input data are placed at a normal position and are classified into an inner side of each class determination boundary. As the time elapses thereafter, a distribution of input data of the class 0 changes. That is, for example, with the learned feature amount of the class 0, input data that is difficult to be classified into the class 0 begins to be input. Moreover, thereafter, the input data of the class 0 crosses the determination boundary, and a correct answer rate of the machine learning model decreases. That is, for example, the feature amount of the input data to be classified into the class 0 changes.

In this way, when the distribution of the input data changes from that at the time of learning after the start of the system operation, as a result, the correct answer rate of the machine learning model decreases, and accuracy deterioration of the machine learning model occurs.

Therefore, as illustrated in FIG. 1, the accuracy deterioration detection device 10 according to the first embodiment uses at least one inspector model (monitor, may be simply referred to as “inspector” below) that solves a problem similar to the machine learning model to be monitored and is generated using a deep neural network (DNN). Specifically, for example, by calculating a matching rate of output of the machine learning model and output of each inspector model for each output class of the machine learning model, the accuracy deterioration detection device 10 detects a change in the distribution of the matching rate, that is, for example, a change in an input data distribution.

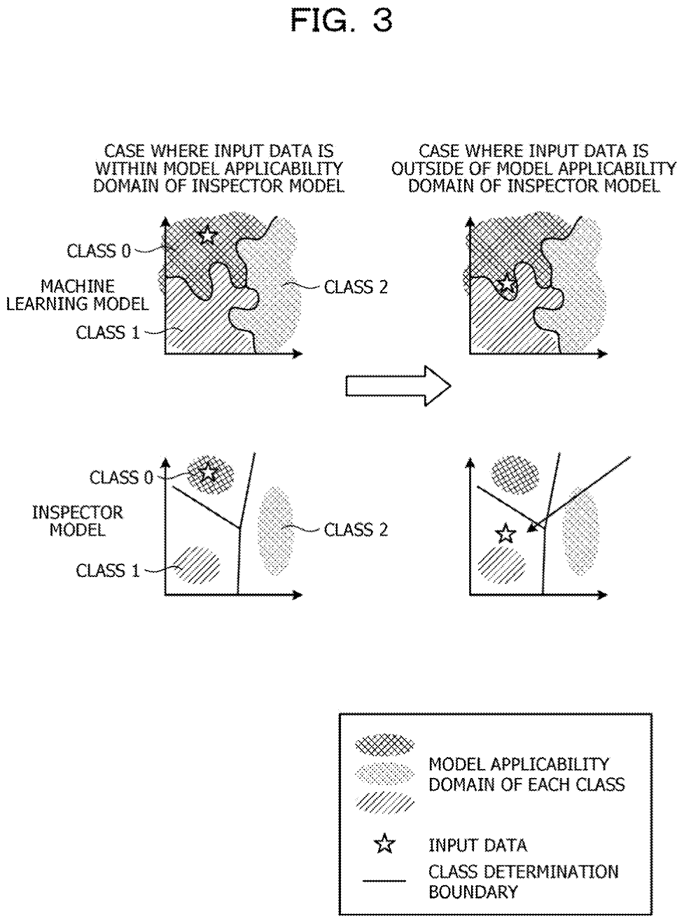

Here, the inspector model will be described. FIG. 3 is a diagram for explaining the inspector model according to the first embodiment. The inspector model is an example of a detection model that is generated under conditions (different model applicability domain) different from the machine learning model. That is, for example, the inspector model is generated so that each region (each feature amount) determined by the inspector model as the class 0, the class 1, or the class 2 is narrower than each region determined by the machine learning model as the class 0, the class 1, or the class 2.

This is because, as the model applicability domain is narrower, a slight change in the input data more sensitively changes the output. Therefore, by narrowing the model applicability domain of the inspector model than the machine learning model to be monitored, an output value of the inspector model fluctuates due to a small change in the input data, and a change in data tendency can be measured according to the matching rate with the output value of the machine learning model.

Specifically, for example, as illustrated in FIG. 3, when the input data is within a range of the model applicability domain of the inspector model, the machine learning model determines the input data as the class 0, and the inspector model also determines the input data as the class 0. That is, for example, both models are within the model applicability domain of the class 0, and the output values constantly match. Therefore, the matching rate does not decrease.

On the other hand, when the input data is outside the range of the model applicability domain of the inspector model, although the machine learning model determines the input data as the class 0, the inspector model does not necessarily determine the input data as the class 0 because the input data is outside the model applicability range of each class. That is, for example, because the output values do not necessarily match, the matching rate decreases.

In this way, the accuracy deterioration detection device 10 according to the first embodiment performs class determination by the inspector model learned to have the model applicability domain narrower than the model applicability domain of the machine learning model, in parallel to the class determination by the machine learning model, and accumulates matching determination results of the both class determinations. Then, by calculating the matching rate indicating reliability of the model and displaying the matching rate on a monitor or the like in real time, the accuracy deterioration detection device 10 can monitor the accuracy of the model during the system operation in real time.

[Functional Structure of Accuracy Deterioration Detection Device]

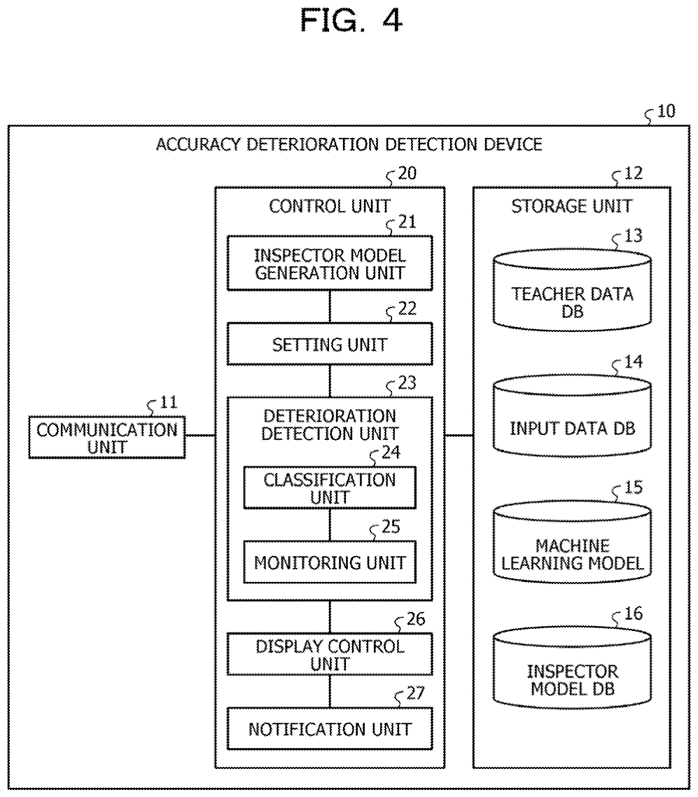

FIG. 4 is a functional block diagram illustrating a functional structure of the accuracy deterioration detection device 10 according to the first embodiment. As illustrated in FIG. 4, the accuracy deterioration detection device 10 includes a communication unit 11, a storage unit 12, and a control unit 20.

The communication unit 11 is a processing unit that controls communication with another device, and is, for example, a communication interface or the like. For example, the communication unit 11 receives various instructions from an administrator's terminal or the like. Furthermore, the communication unit 11 receives input data to be determined from various terminals.

The storage unit 12 is an example of a storage device that stores data and a program or the like executed by the control unit 20, and is, for example, a memory, a hard disk, or the like. The storage unit 12 includes a teacher data DB 13, an input data DB 14, a machine learning model 15, and an inspector model DB 16.

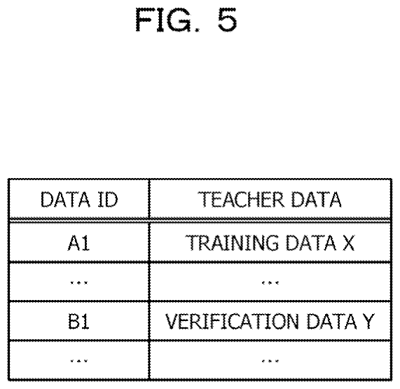

The teacher data DB 13 is a database that stores teacher data used to learn the machine learning model that is teacher data also used to learn the inspector model. FIG. 5 is a diagram illustrating an example of information stored in the teacher data DB 13. As illustrated in FIG. 5, the teacher data DB 13 stores a data ID and teacher data in association with each other.

The stored data ID here is an identifier for identifying teacher data. The teacher data is training data used for learning or verification data used for verification at the time of learning. In the example in FIG. 5, training data X of which a data ID is “A1” and verification data Y of which a data ID is “B1” are illustrated. Note that the training data and the verification data are data in which image data that is an explanatory variable is associated with correct answer information (label) that is an objective variable.

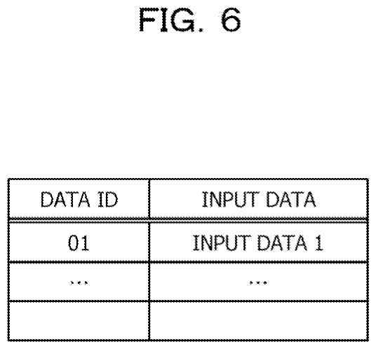

The input data DB 14 is a database that stores input data to be determined. Specifically, for example, the input data DB 14 stores image data to be input to the machine learning model that is image data to be image-classified. FIG. 6 is a diagram illustrating an example of information stored in the input data DB 14. As illustrated in FIG. 6, the input data DB 14 stores a data ID and input data in association with each other.

The stored data ID here is an identifier for identifying input data. The input data is image data to be classified. In the example in FIG. 6, input data 1 of which a data ID is “01” is illustrated. It is not necessary to store the input data in advance, and the input data may be transmitted as a data stream from another terminal.

The machine learning model 15 is a learned machine learning model and is a model to be monitored by the accuracy deterioration detection device 10. Note that, the machine learning model 15 of a neural network, a support vector machine, or the like to which a learned parameter is set can be stored, and the learned machine learning model 15 may also store a learned parameter or the like that can be constructed.

The inspector model DB 16 is a database that stores information regarding at least one inspector model used to detect accuracy deterioration. For example, the inspector model DB 16 stores parameters used to construct the inspector model that are various parameters of the DNN generated (optimized) through machine learning by the control unit 20 to be described later. Note that the inspector model DB 16 can store a learned parameter and can store an inspector model (DNN) to which the learned parameter is set.

The control unit 20 is a processing unit that controls the entire accuracy deterioration detection device 10 and is, for example, a processor or the like. The control unit 20 includes an inspector model generation unit 21, a setting unit 22, a deterioration detection unit 23, a display control unit 26, and a notification unit 27. Note that the inspector model generation unit 21, the setting unit 22, the deterioration detection unit 23, the display control unit 26, and the notification unit 27 are examples of an electronic circuit included in a processor, examples of a process to be executed by the processor, or the like.

The inspector model generation unit 21 is a processing unit that generates the inspector model that is an example of a monitor or a detection model that detects the accuracy deterioration of the machine learning model 15. Specifically, for example, the inspector model generation unit 21 generates inspector models having different model applicability ranges through deep learning using the teacher data used to learn the machine learning model 15. Then, the inspector model generation unit 21 stores various parameters used to construct the inspector models (DNN), obtained through deep learning, having different model applicability ranges in the inspector model DB 16.

For example, by controlling the number of pieces of training data, the inspector model generation unit 21 generates the plurality of inspector models having the different applicable ranges. Generally, as the number of pieces of training data increases, more feature amounts are learned. Therefore, more comprehensive learning is performed, and a model having a wider model applicability range is generated. On the other hand, as the number of pieces of training data decreases, the number of feature amounts of the teacher data to be learned is smaller. Therefore, a covered range (feature amount) is limited, and a model having a narrow model applicability range is generated.

Note that, in the first embodiment, an example using a single inspector model will be described. However, the inspector model generation unit 21 can generate a plurality of inspector models by changing the number of pieces of training data as setting the number of times of training to be the same. For example, a case will be considered where five inspector models are generated in a state where the machine learning model 15 is learned with the number of times of training (100 epochs) and the number of pieces of training data (1000 pieces per class). In this case, the inspector model generation unit 21 determines the number of pieces of training data of an inspector model 1 as “500 pieces per class”, the number of pieces of training data of an inspector model 2 as “400 pieces per class”, the number of pieces of training data of an inspector model 3 as “300 pieces per class”, the number of pieces of training data of an inspector model 4 as “200 pieces per class”, and the number of pieces of training data of an inspector model 5 as “100 pieces per class”, randomly selects teacher data from the teacher data DB 13, and learns each piece of the teacher data with 100 epochs.

Thereafter, the inspector model generation unit 21 stores various parameters of each of the learned inspector models 1 to 5 in the inspector model DB 16. In this way, the inspector model generation unit 21 can generate the five inspector models that have model applicability ranges narrower than the applicable range of the machine learning model 15 and are different from each other.

Note that the inspector model generation unit 21 can learn each inspector model using a method such as error back propagation and can adopt another method. For example, the inspector model generation unit 21 learns the inspector model (DNN) by updating the parameter of the DNN so as to reduce an error between an output result obtained by inputting the training data into the inspector model and a label of the input training data.

The setting unit 22 is a processing unit that sets a threshold used to determine deterioration and the prescribed number of pieces of data used to calculate a matching rate. For example, the setting unit 22 reads the machine learning model 15 from the storage unit 12 and reads various parameters from the inspector model DB 16 and constructs the learned inspector model. Then, the setting unit 22 reads each piece of the verification data stored in the teacher data DB 13, inputs the read data into the machine learning model 15 and the inspector model, and acquires a distribution result to the model applicability domain based on each output result (classification result).

Thereafter, the setting unit 22 calculates a matching rate between the classes of the machine learning model 15 and the inspector model 1 with respect to the verification data. Then, the setting unit 22 sets a threshold using the matching rate. For example, the setting unit 22 displays the matching rate on a display or the like and accepts the setting of the threshold from a user. Furthermore, when the plurality of inspector models is used, the setting unit 22 can select and set any one of an average value of the matching rates, a maximum value of the matching rates, a minimum value of the matching rates, or the like according to a deterioration state that the user requests to detect.

Furthermore, the setting unit 22 displays a setting screen or the like and accepts designation of the prescribed number for the matching rate calculation. For example, when 100 is set, the matching rate is calculated after matching determination on 100 pieces of input data is completed. Furthermore, not only the number of pieces of data but also an interval such as one hour or one month can be designated, and in this case, the matching rate is calculated at every set intervals.

Note that, the number (prescribed number) of pieces of input data used to calculate the matching rate can be arbitrarily determined by the user. The larger the prescribed number is, the smaller a reliability error is, and the number of pieces of data needed for calculation increases.

Returning to FIG. 4, the deterioration detection unit 23 is a processing unit that includes a classification unit 24 and a monitoring unit 25, compares the output result of the machine learning model 15 and the output result of the inspector model for the input data, and detects accuracy deterioration of the machine learning model 15.

The classification unit 24 is a processing unit that inputs the input data to each of the machine learning model 15 and the inspector model and acquires each output result (classification result). For example, the classification unit 24 acquires the parameter of the inspector model from the inspector model DB 16 and constructs the inspector model when learning of the inspector model is completed and executes the machine learning model 15.

Then, the classification unit 24 inputs the input data to the machine learning model 15 and acquires the output result, and inputs the input data to the inspector model (DNN) and acquires each output result. Thereafter, the classification unit 24 stores the input data and each output result in the storage unit 12 in association with each other and outputs the stored data and result to the monitoring unit 25.

The monitoring unit 25 is a processing unit that monitors accuracy deterioration of the machine learning model 15 using the output result of the inspector model. Specifically, for example, the monitoring unit 25 measures a change in a distribution of a matching rate between the output of the machine learning model 15 and the output of the inspector model, for each class. For example, the monitoring unit 25 performs matching determination between the output result of the machine learning model 15 and the output result of the inspector model for each piece of the input data and accumulates the matching determination result in the storage unit 12 or the like.

Then, the monitoring unit 25 calculates the matching rate for each inspector model or each class using the matching determination result between the output of the machine learning model 15 and the output of the inspector model at intervals set by the setting unit 22. For example, when a set value is 100 pieces of data, the monitoring unit 25 calculates the matching rate when matching determination of the 100 pieces of input data is completed. Furthermore, when the set value is one hour, the monitoring unit 25 calculates the matching rate each hour. Thereafter, the monitoring unit 25 stores the matching determination result in the storage unit 12 or outputs the matching determination result to the display control unit 26.

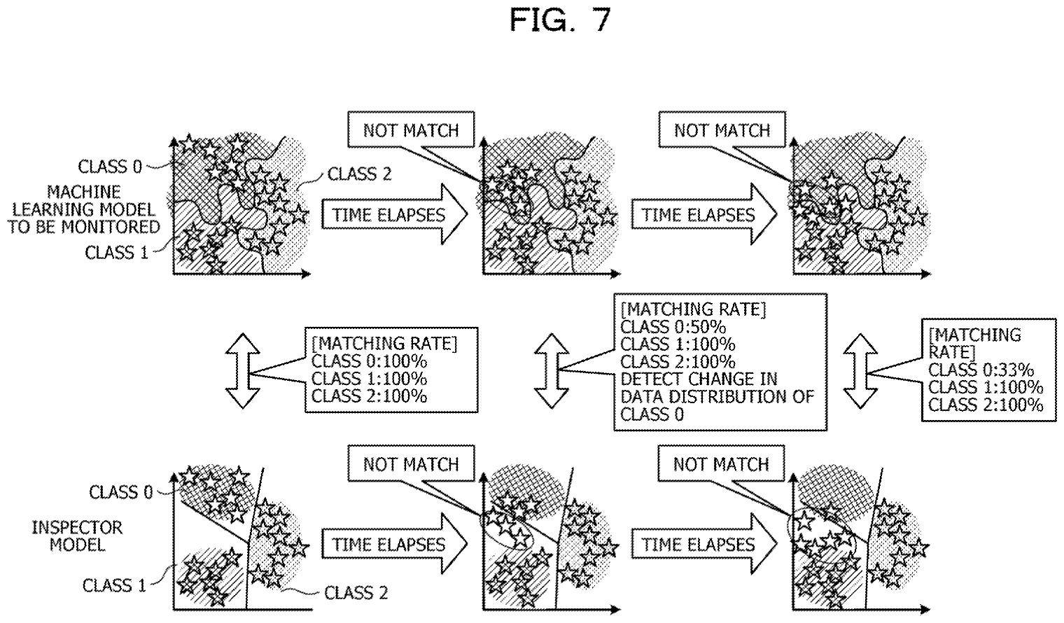

FIG. 7 is a diagram for explaining detection of the accuracy deterioration. FIG. 7 illustrates an output result of the machine learning model 15 to be monitored and an output result of the inspector model, for the input data. Here, for easy explanation, a probability that the output of the machine learning model 15 to be monitored matches the output of the inspector model will be described using a data distribution to the model applicability domain in the feature amount space.

As illustrated in FIG. 7, the monitoring unit 25 acquires that six pieces of input data belongs to a model applicability domain of the class 0, six pieces of input data belongs to a model applicability domain of the class 1, and eight pieces of input data belongs to a model applicability domain of the class 2 from the machine learning model 15 to be monitored at the time of starting the operation. On the other hand, the monitoring unit 25 acquires that six pieces of input data belongs to the model applicability domain of the class 0, six pieces of input data belongs to the model applicability domain of the class 1, and eight pieces of input data belongs to the model applicability domain of the class 2 from the inspector model.

That is, for example, the monitoring unit 25 calculates a matching rate as 100% because the matching rates of each class of the machine learning model 15 and the inspector model match. At this timing, each of the classification results matches.

As the time elapses, the monitoring unit 25 acquires that six pieces of input data belongs to the model applicability domain of the class 0, six pieces of input data belongs to the model applicability domain of the class 1, and eight pieces of input data belongs to the model applicability domain of the class 2 from the machine learning model 15 to be monitored. On the other hand, the monitoring unit 25 acquires that three pieces of input data belongs to the model applicability domain of the class 0, six pieces of input data belongs to the model applicability domain of the class 1, and eight pieces of input data belongs to the model applicability domain of the class 2 from the inspector model.

That is, for example, the monitoring unit 25 calculates a matching rate of the class 0 as 50% (( 3/6)×100) and calculates matching rates of the classes 1 and 2 as 100%. In other words, for example, a change in data distribution of the class 0 is detected. At this timing, the inspector model is in a state where the three pieces of input data that is not classified into the class 0 is not necessarily classified into the class 0.

As the time further elapses, the monitoring unit 25 acquires that three pieces of input data belongs to the model applicability domain of the class 0, six pieces of input data belongs to the model applicability domain of the class 1, and eight pieces of input data belongs to the model applicability domain of the class 2 from the machine learning model 15 to be monitored. On the other hand, the monitoring unit 25 acquires that one piece of input data belongs to the model applicability domain of the class 0, six pieces of input data belongs to the model applicability domain of the class 1, and eight pieces of input data belongs to the model applicability domain of the class 2 from the inspector model.

That is, for example, the monitoring unit 25 calculates a matching rate of the class 0 as 33% ((⅓)×100) and calculates matching rates of the classes 1 and 2 as 100%. In other words, for example, it is determined that the data distribution of the class 0 is changed. A state at this timing is where the machine learning model 15 does not classify input data to be classified into the class 0 into the class 0, and the inspector model does not necessarily classify five pieces of input data, which has not been classified into the class 0, into the class 0.

In this way, each time when input data prediction (determination) processing is executed, the monitoring unit 25 performs the matching determination between the machine learning model 15 and the inspector model. Then, the monitoring unit 25 periodically calculates the matching rate.

Returning to FIG. 4, the display control unit 26 is a control unit that outputs a calculation result of the matching rate by the monitoring unit 25 to a display device (not illustrated) such as a monitor. For example, the display control unit 26 displays the change in the matching rate calculated by the monitoring unit 25 at a timing designated by a user.

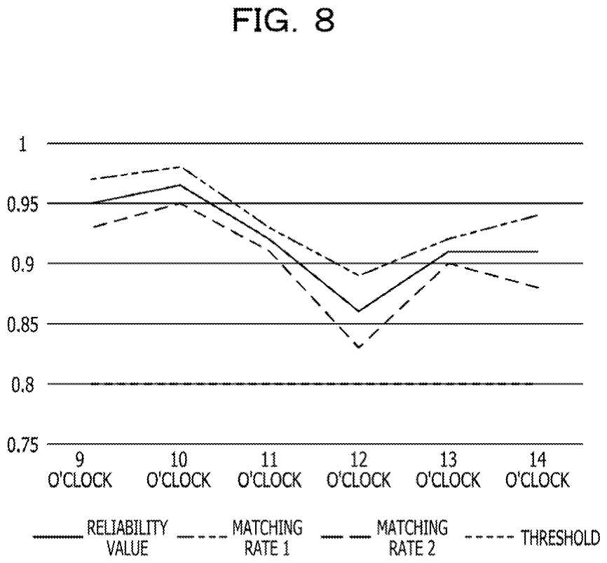

FIG. 8 is a diagram for explaining real-time display of an accuracy state. In FIG. 8, a change in the matching rate each hour is illustrated. As illustrated in FIG. 8, the display control unit 26 displays a matching rate 1 of the class 1 and a matching rate 2 of the class 2 each hour and displays reliability that is an average value of the matching rates 1 and 2 and a threshold set by a user.

In the example in FIG. 8, an example is illustrated in which the reliability is the highest at 10 o'clock, and although the reliability decreases from 10 o'clock to 12 o'clock, the reliability is restored at or after 12 o'clock. That is, for example, although the distribution of the input data starts to differ from that at the time of learning between 10 o'clock and 12 o'clock, it can be determined that the entire input data does not change.

Note that a timing when the matching rate is calculated may be different from a display interval (horizontal axis illustrated in FIG. 8) of the change of the matching rate. For example, the monitoring unit 25 can calculate the matching rate of each class for each 100 pieces of data, and the display control unit 26 can display an average value, a minimum value, or the like of the matching rate within a time period (within one hour) each hour. In this case, when a graph of the matching rate of each class is selected, the display control unit 26 can display the matching rate for each 100 pieces of data calculated by the monitoring unit 25.

Returning to FIG. 4, the notification unit 27 is a processing unit that issues an alert to a user when the reliability decreases. For example, when the reliability is less than the threshold designated by a user, the notification unit 27 displays a message indicating that the reliability decreases or the like on the monitor or transmits the message via a mail.

Note that alert notification conditions can be arbitrarily set and changed. For example, the notification unit 27 can issue an alert at any designated timing such as a case where any one of the matching rates is less than the threshold, a case where the reliabilities less than the threshold are continuously detected, a case where the number of times when the reliability is less than the threshold becomes equal to or more than the threshold, or the like.

[Flow of Processing]

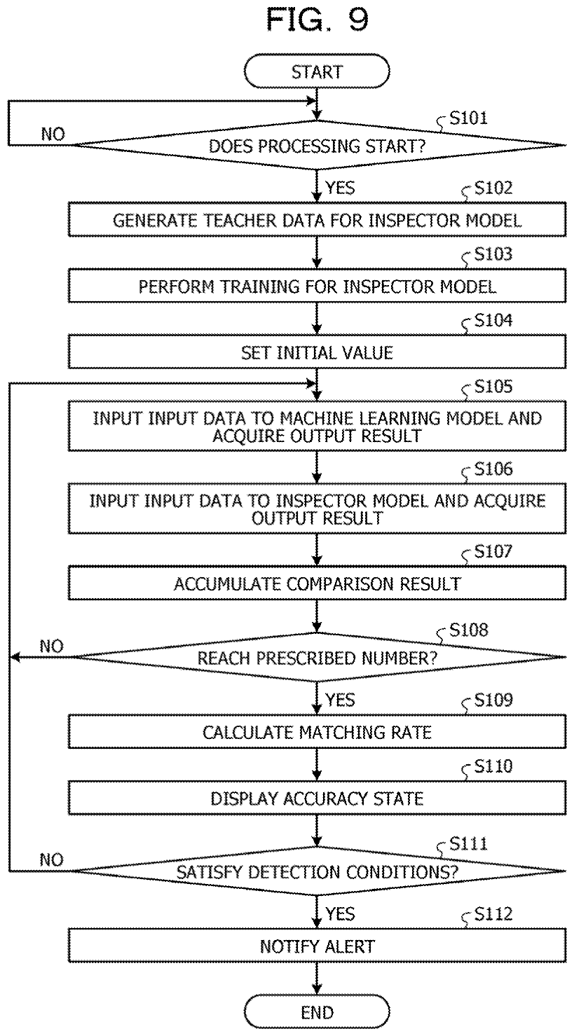

FIG. 9 is a flowchart illustrating a flow of processing according to the first embodiment. As illustrated in FIG. 9, when the processing starts (S101: Yes), the inspector model generation unit 21 generates teacher data for an inspector model by reducing the number of pieces of data to be less than the number of pieces of data of the machine learning model 15 (S102). Then, the inspector model generation unit 21 performs training for the inspector model using training data in the generated teacher data and generates an inspector model (S103).

Subsequently, the setting unit 22 sets an initial value (S104). For example, the setting unit 22 sets a threshold used to determine deterioration and the prescribed number of pieces of data used to calculate a matching rate.

Thereafter, the deterioration detection unit 23 inputs the input data to the machine learning model 15 and acquires an output result (S105) and inputs the input data to the inspector model and acquires an output result (S106).

Then, the deterioration detection unit 23 accumulates comparison between the output results, in other words, for example, a matching determination result between the output result of the machine learning model 15 and the output result of the inspector model for the input data (S107). Then, until the number of accumulations, the number of pieces of processed input data, or the like reaches the prescribed number (S108: No), S105 and subsequent processing are repeated.

Thereafter, when the number of processing or the like reaches the prescribed number (S108: Yes), the deterioration detection unit 23 calculates the matching rate between each inspector model and the machine learning model 15 for each class (S109). Then, the display control unit 26 displays the accuracy state including the matching rate and the reliability on the monitor or the like (S110).

Here, when the reliability does not satisfy detection conditions (S111: No), S105 and subsequent processing are repeated, and when the reliability satisfies the detection conditions (S111: Yes), the notification unit 27 issues an alert (S112).

[Effects]

As described above, because the matching rate between the output of the learned machine learning model 15 to be monitored and the output of the inspector model is almost proportional to a correct answer rate of the output of the machine learning model 15, the accuracy deterioration detection device 10 uses the value of the matching rate to measure the reliability of the machine learning model 15. In this way, correctness information (correctness deterioration by human) of the output of the machine learning model 15 is unnecessary by using the matching rate to measure the reliability, the accuracy deterioration detection device 10 can automatically monitor the reliability.

Furthermore, the accuracy deterioration detection device 10 accumulates the matching determination result of each input data so as to calculate the matching rate for the prescribed number of pieces of latest input data at any timing. Therefore, the accuracy deterioration detection device 10 can measure and output the reliability of the model in real time.

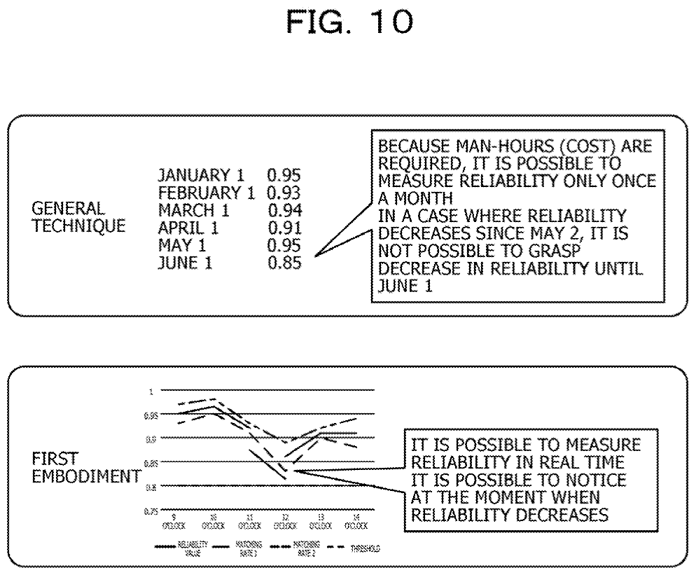

FIG. 10 is a diagram explaining effects. FIG. 10 illustrates comparison between general monitoring using a T² statistics amount or the like and monitoring according to the first embodiment. As illustrated in FIG. 10, according to the general technique, because the T² statistics amount is manually calculated, displayed, compared, or the like, more man-hours (cost) are needed. Therefore, it is possible to measure the reliability about only once a month. Therefore, for example, when the reliability decreases from May 2, it is not possible to grasp the decrease in the reliability until June 1.

On the other hand, according to the method of the embodiment, because the matching rate can be automatically calculated as described above and the reliability can be displayed, the reliability can be measured in real time. Therefore, the accuracy deterioration detection device 10 can notify a user at the time when the reliability decreases.

[Specific Example]

Next, a specific example for detecting the accuracy deterioration by the inspector model using an image classifier as the machine learning model 15 will be described. The image classifier is a machine learning model that classifies an input image for each class (category). For example, in a clothing mail-order site, an auction site where clothing is bought or sold between individuals, or the like, an image of clothing is uploaded to the site, and a category of the clothing is registered on the site. In order to automatically register the category of the uploaded image to the site, the category of the clothing is predicted from the image using the machine learning model. When tendency (data distribution) of the image of the clothing to be uploaded changes during the system operation, accuracy of the machine learning model deteriorates. According to the general technique, whether the prediction result is correct or wrong is manually confirmed, a correct answer rate is calculated, and the model accuracy deterioration is detected. Therefore, by applying the method according to the first embodiment, the model accuracy deterioration is detected without using the correctness information of the prediction result.

For example, a system indicated in the specific example is a system that inputs the input data to each of the image classifier and the inspector model, periodically calculates the reliability of the image classifier using the matching rate of the data distributions of the model applicability domains of the image classifier and the inspector model and displays the calculated reliability on the monitor.

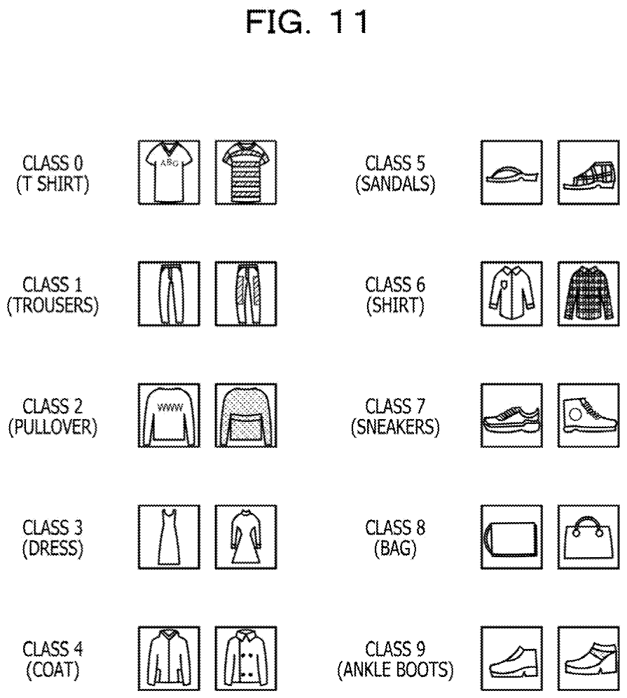

Next, the teacher data will be described. FIG. 11 is a diagram for explaining a specific example of the teacher data. As illustrated in FIG. 11, the teacher data uses image data of each of a T shirt of which a label is a class 0, trousers of which a label is a class 1, a pullover of which a label is a class 2, a dress of which a label is a class 3, and a coat of which a label is a class 4. Furthermore, image data of each of sandals of which a label is a class 5, a shirt of which a label is a class 6, sneakers of which a label is a class 7, a bag of which a label is a class 8, and ankle boots of which a label is a class 9 is used.

Here, the image classifier is a classifier using a DNN that performs 10-class classification and is trained with 1000 pieces of teacher data per class and 100 epochs as the number of times of training. Furthermore, the inspector model is a detector using the DNN that performs 10-class classification and is trained with 200 pieces of teacher data per class and 100 epochs as the number of times of training. That is, for example, model applicability domains of the image classifier and the inspector model are narrower in this order. Note that the teacher data has been randomly selected from among the teacher data of the image classifier. Furthermore, a threshold of the matching rate of each class is set to 0.7.

In such a state, as the input data, an image (grayscale) of clothing (any one of 10 classes) is used as in the teacher data. Note that the input image may be a colored image. The input data suitable for the image classifier (machine learning model 15) to be monitored is used.

In such a state, the accuracy deterioration detection device 10 inputs data input to the image classifier to be monitored to the inspector model, compares outputs, and accumulates comparison results (matched or not matched) for each output class of the image classifier. Then, the accuracy deterioration detection device 10 calculates a matching rate and reliability of each class from the accumulated comparison results (for example, the latest 100 results/class) and displays the matching rate and the reliability on the monitor. Then, when the reliability is less than a threshold, the accuracy deterioration detection device 10 outputs an alert of accuracy deterioration detection.

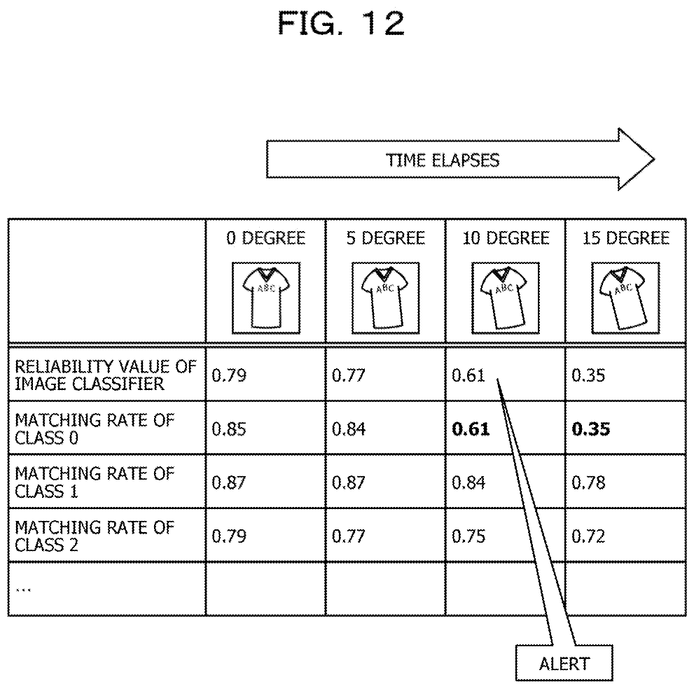

FIG. 12 is a diagram for explaining an execution result of the accuracy deterioration detection. FIG. 12 illustrates an execution result of a case where only an image of the class 0 (T-shirt) is gradually rotated and a tendency changes, in the input data. At the time when the data of the class 0 rotates by 10 degrees, the matching rate (0.61) of the class 0 falls below the threshold, the reliability of the entire model falls below the threshold, and the accuracy deterioration detection device 10 has notified the alert. Note that, although the matching rate (0.35) of the class 0 significantly decreases at the time when the data rotates by 15 degrees, the accuracy deterioration detection device 10 can perform user notification by detecting the model accuracy deterioration and displaying the detected accuracy deterioration on the monitor at the time when a correct answer rate of the image classifier slightly decreases.

As a result, the accuracy deterioration detection device 10 can reduce system operation man-hours that are needed for reliability monitoring of the model. Furthermore, the accuracy deterioration detection device 10 can measure a value of the reliability in real time and perform monitoring, and can prevent the system from being used in a state where the reliability of the model decreases.

### Second Embodiment

By the way, the input data to be determined (predicted) may be periodically changed due to not only so-called domain shift but also time or seasons. When the inspector model described above strictly determines the matching rate, there is a possibility that the model accuracy deterioration is erroneously detected for data of which a data distribution periodically changes in this way.

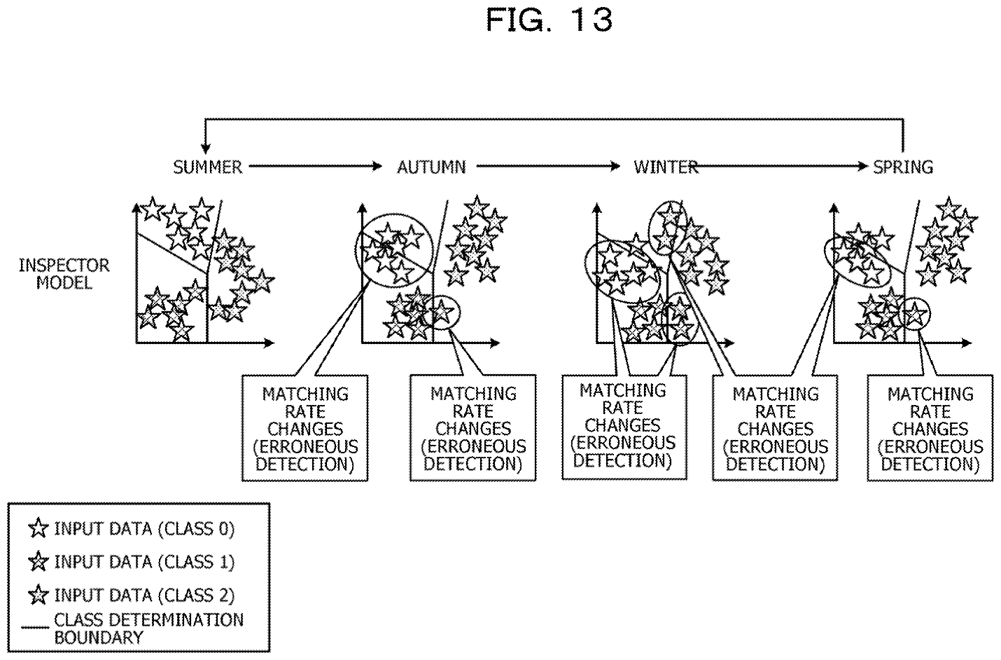

FIG. 13 is a diagram for explaining erroneous detection of data that periodically changes. FIG. 13 illustrates a distribution of seasonal input data. The input data here is image data captured in each season, a sensor value measured in each season, or the like. That is, for example, the input data is data collected in an imaging environment in which a light amount, a noise, or the like differs for each season.

As illustrated in FIG. 13, the generated inspector model is a classifier that can correctly classify summer input data into classes. When such an inspector model is applied to autumn data, it can be assumed that a feature amount of the autumn data is different from the summer data. Therefore, there is a case where it is not possible to correctly classify the autumn data into classes and erroneous detection is performed in the class 0 or the class 1.

Furthermore, there is a case where it is not possible for the inspector model to correctly classify winter data into classes and erroneous detection is performed in each of the classes 0 to 2, and there is a case where erroneous detection is performed in the class 0 or the class 1 for spring data.

In this way, the matching rate changes due to the change in the data distribution of the input data, and the inspector model according to the first embodiment detects the model accuracy deterioration. Therefore, there is a possibility that the matching rate changes with respect to the change in the data distribution that causes no problem such as a periodical change in the data distribution and erroneous detection occurs.

Therefore, the accuracy deterioration detection device 10 according to the second embodiment extracts training data within a period obtained by dividing a cycle by any number so as to generate each inspector model corresponding to each period, and does not determine that the accuracy deterioration occurs in a case where the matching rate of the one or more inspector models is high and determines that the accuracy deterioration occurs only when the matching rates of all the inspector models decrease. In this way, the accuracy deterioration detection device 10 according to the second embodiment can automatically detect the accuracy deterioration of the machine learning model of which the distribution of the input data periodically changes.

[Functional Structure of Accuracy Deterioration Detection Device 50]

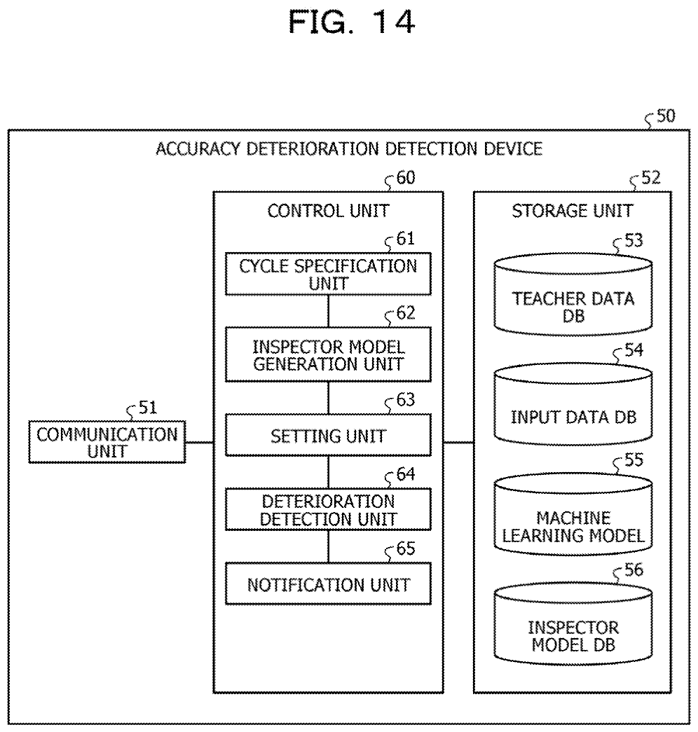

FIG. 14 is a functional block diagram illustrating a functional structure of an accuracy deterioration detection device 50 according to the second embodiment. As illustrated in FIG. 14, the accuracy deterioration detection device 50 includes a communication unit 51, a storage unit 52, and a control unit 60.

The communication unit 51 is a processing unit that controls communication with another device and is, for example, a communication interface or the like. For example, the communication unit 51 receives various instructions from an administrator's terminal or the like. Furthermore, the communication unit 51 receives input data to be determined (predicted) from various terminals.

The storage unit 52 is an example of a storage device that stores data and a program or the like executed by the control unit 60, and is, for example, a memory, a hard disk, or the like. The storage unit 52 stores a teacher data DB 53, an input data DB 54, a machine learning model 55, and an inspector model DB 56. Note that, because the teacher data DB 53, the input data DB 54, the machine learning model 55, and the inspector model DB 56 have similar structures to those of the teacher data DB 13, the input data DB 14, the machine learning model 15, and the inspector model DB 16 described with reference to FIG. 4, detailed description will be omitted.

The control unit 60 is a processing unit that controls the entire accuracy deterioration detection device 50 and is, for example, a processor or the like. The control unit 60 includes a cycle specification unit 61, an inspector model generation unit 62, a setting unit 63, a deterioration detection unit 64, and a notification unit 65. Note that the cycle specification unit 61, the inspector model generation unit 62, the setting unit 63, the deterioration detection unit 64, and the notification unit 65 are examples of an electronic circuit included in a processor, examples of a process executed by a processor, or the like.

The cycle specification unit 61 is a processing unit that confirms a cycle of a distribution change in input data of the machine learning model 15 to be monitored, extracts input data within a period obtained by dividing one cycle by the number of inspector models, and sets the input data as training data for each inspector model. For example, the cycle is not limited to seasons, and various cycles can be adopted such as morning (from 6:00 to 11:00), afternoon (from 12:00 to 15:00), evening (from 15:00 to 18:00), and night (from 19:00 to 6:00).

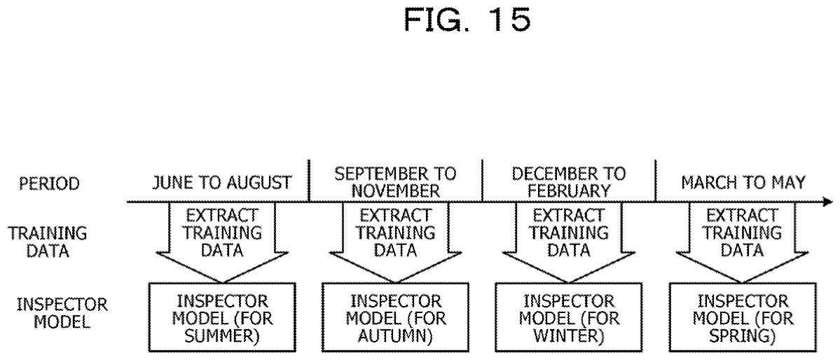

Here, an example will be described using seasons. FIG. 15 is a diagram for explaining learning of an inspector model according to the second embodiment. As illustrated in FIG. 15, from teacher data stored in the teacher data DB 53, the cycle specification unit 61 extracts teacher data imaged from June to August, extracts teacher data imaged from September to November, extracts teacher data imaged from December to February, and extracts teacher data imaged from March to May. Then, the cycle specification unit 61 stores each piece of the extracted data in the storage unit 52 and outputs the data to the inspector model generation unit 62.

The inspector model generation unit 62 is a processing unit that generates an inspector model that detects model accuracy deterioration for a data distribution at each timing in one cycle in order to make the data distribution correspond to a distribution of input data that periodically changes.

As described with reference to the example described above, the inspector model generation unit 62 generates an inspector model (for summer) through supervised learning using the teacher data imaged from June to August and generates an inspector model (for autumn) through supervised learning using the teacher data imaged from September to November. Furthermore, the inspector model generation unit 62 generates an inspector model (for winter) through supervised learning using the teacher data imaged from December to February and generates an inspector model (for spring) through supervised learning using the teacher data imaged from March to May. Note that the inspector model generation unit 62 stores a learning result (generation result) of each inspector model in the inspector model DB 56.

The setting unit 63 is a processing unit that sets a threshold used to determine deterioration and the prescribed number of pieces of data used to calculate a matching rate. For example, the setting unit 63 sets each threshold or the like with a method similar to that of the setting unit 22 according to the first embodiment with reference to FIG. 4.

The deterioration detection unit 64 is a processing unit that compares an output result of the machine learning model 15 and an output result of the inspector model for the input data and detects accuracy deterioration of the machine learning model 15. Specifically, for example, the deterioration detection unit 64 executes processing similar to that of the classification unit 24 and the monitoring unit 25 according to the first embodiment and detects the accuracy deterioration of the machine learning model 15.

For example, similarly to the classification unit 24, the deterioration detection unit 64 inputs the input data to each of the machine learning model 15 and the inspector model and acquires each output result (classification result). Then, similarly to the monitoring unit 25, the deterioration detection unit 64 performs matching determination between the output result of the machine learning model 15 and the output result of the inspector model for each piece of the input data and accumulates the matching determination result in the storage unit 12 or the like. Thereafter, the deterioration detection unit 64 calculates a matching rate of the machine learning model 15 and each inspector model at a predetermined timing, and outputs the matching rate to the notification unit 65.

As in the first embodiment, the notification unit 65 is a processing unit that issues an alert to a user in a case where reliability decreases. For example, the notification unit 65 determines accuracy deterioration based on the matching rate of each inspector model calculated by the deterioration detection unit 64 and issues an alert when the accuracy deterioration is detected.

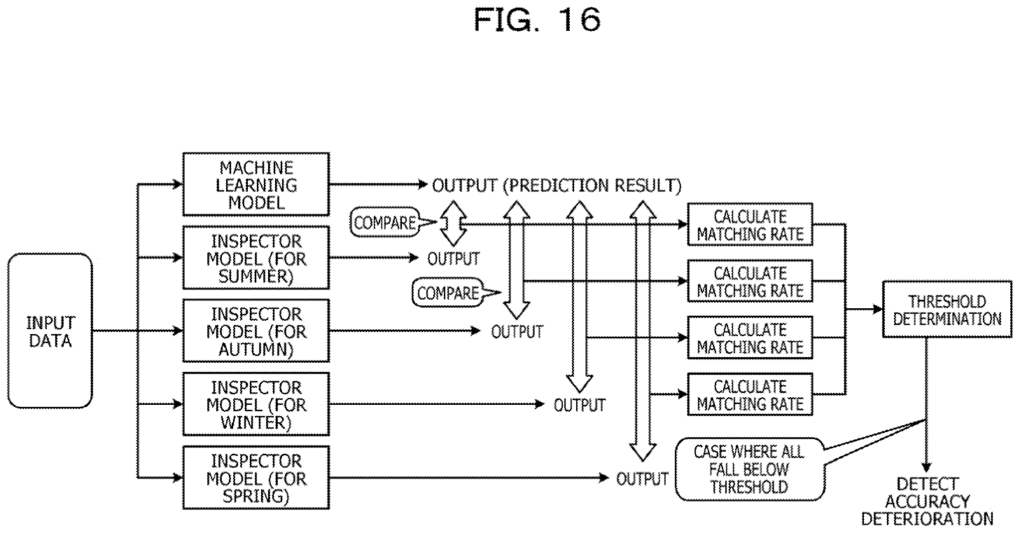

FIG. 16 is a diagram for explaining the detection of the accuracy deterioration according to the second embodiment. As illustrated in FIG. 16, the deterioration detection unit 64 compares the output result of the machine learning model 15 and the inspector model (for summer) and calculates a matching rate and compares the output result of the machine learning model 15 and the inspector model (for autumn) and calculates a matching rate. Similarly, the deterioration detection unit 64 compares the output result of the machine learning model 15 and the inspector model (for winter) and calculates a matching rate and compares the output result of the machine learning model 15 and the inspector model (for spring) and calculates a matching rate.

Then, the notification unit 65 performs threshold determination. Because the distribution of the input data periodically changes, even when a matching rate of a specific inspector model decreases, the model accuracy deterioration does not necessarily occurs. Therefore, the notification unit 65 compares each matching rate with the threshold, and in a case where all the matching rates are less than the threshold, the notification unit 65 detects the accuracy deterioration and issues an alert.

[Flow of Processing]

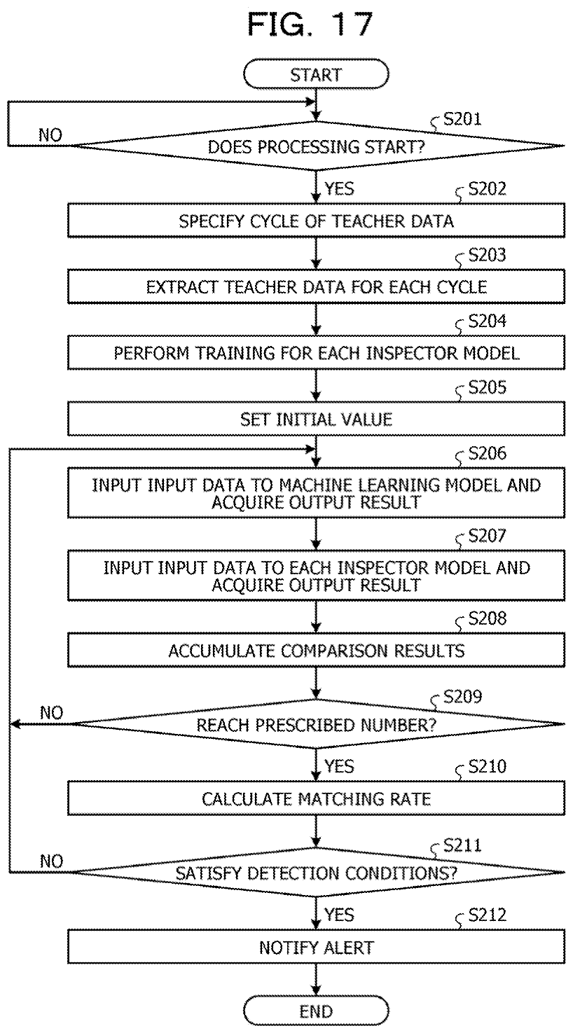

FIG. 17 is a flowchart illustrating a flow of processing according to the second embodiment. As illustrated in FIG. 17, when the processing is started (S201: Yes), the cycle specification unit 61 specifies a cycle of teacher data (S202) and extracts teacher data for each cycle (S203). For example, by referring to user designation or a date and time when the teacher data is imaged, the cycle specification unit 61 classifies the period into seasons, time periods, or the like and extracts teacher data.

Subsequently, the inspector model generation unit 62 performs training for an inspector model for each cycle using training data in teacher data corresponding to each cycle and generates each inspector model (S204). Subsequently, the setting unit 63 sets an initial value (S205).

Thereafter, the deterioration detection unit 64 inputs the input data to the machine learning model 15 and acquires an output result (S206) and inputs the input data to the inspector model and acquires an output result (S207).

Then, the deterioration detection unit 64 accumulates a matching determination result between the output result of the machine learning model 15 and the output result of the inspector model for the input data (S208). Then, until the number of accumulations, the number of pieces of processed input data, or the like reaches the prescribed number (S209: No), S206 and subsequent processing are repeated.

Thereafter, when the number of processing or the like reaches the prescribed number (S209: Yes), the deterioration detection unit 64 calculates the matching rate between each inspector model and the machine learning model 15 for each class (S210). Here, when the matching rate does not satisfy detection conditions (S211: No), S206 and subsequent processing are repeated, and when the matching rate satisfies the detection conditions (S211: Yes), the notification unit 65 issues an alert (S212).

[Effects]

As described above, the accuracy deterioration detection device 50 according to the second embodiment confirms the cycle of the distribution change in the input data of the machine learning model 15 to be monitored, extracts the input data within the period obtained by dividing one cycle by the number of inspector models, and sets the input data as training data for each inspector model. The accuracy deterioration detection device 50 according to the second embodiment uses the inspector model in each period when the training data described above is learned to detect the model accuracy deterioration and calculates the matching rate. Even when the matching rate decreases, when the matching rate of one or more inspector models is high, the accuracy deterioration detection device 50 according to the second embodiment does not determine that the accuracy deterioration occurs, and determines that the accuracy deterioration occurs only when the matching rates of all the inspector models decrease.

As a result, the accuracy deterioration detection device 50 according to the second embodiment can automatically detect the accuracy deterioration of the machine learning model of which the distribution of the input data periodically changes and can prevent erroneous detection from the data, of which the distribution periodically changes, such as seasonal data.

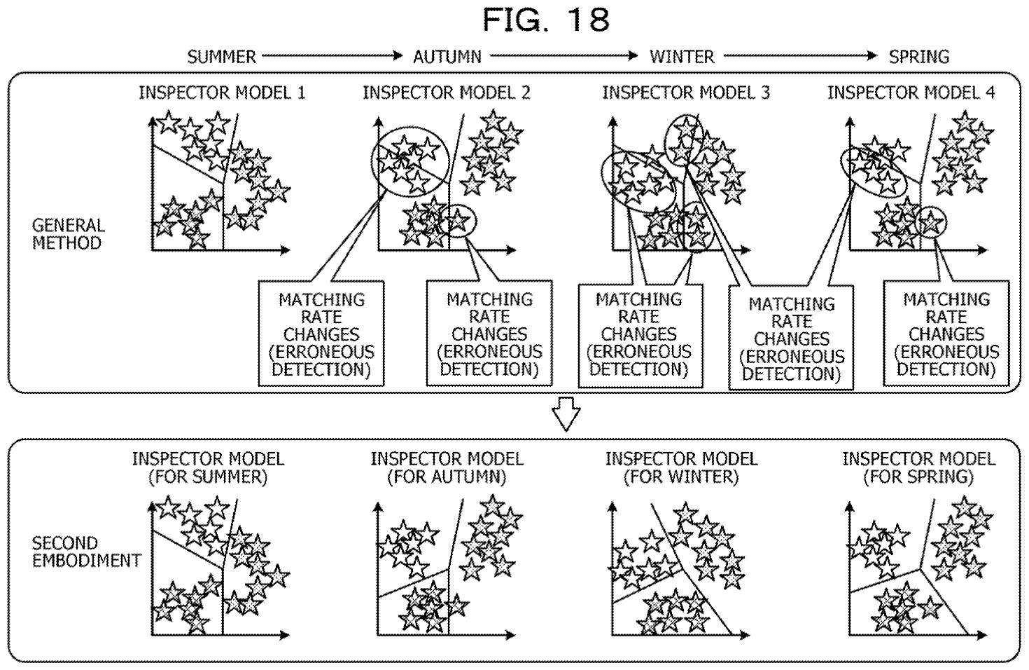

FIG. 18 is a diagram for explaining effects of the second embodiment. As illustrated in the upper figure in FIG. 18, when accuracy deterioration is detected using only one inspector model, summer input data can be correctly classified into classes. However, it is not possible to correctly perform class classification on each of autumn, winter, and spring data of which a feature amount is different from that of the summer data, and there is a case where erroneous detection is performed in the class 0 or the class 1.

On the other hand, as illustrated in the figure below in FIG. 18, each inspector model learned using the training data that is different for each season has a different determination region in the feature amount space, and a model applicability domain suitable for each season is generated through learning. Therefore, even if the feature amount of the input data slightly changes due to an effect of the season, the accuracy deterioration detection device 50 according to the second embodiment can maintain the matching rate of any inspector model to be equal to or more than the threshold by using the inspector model suitable for each season. Then, because the matching rates of all the inspector models become less than the threshold when the input data largely changes regardless of the season, the accuracy deterioration detection device 50 according to the second embodiment can accurately detect a timing of relearning of the machine learning model 15.

[Specific Example]

Next, a specific example of the second embodiment will be described. The machine learning model 15 to be used as an image classifier is a classifier using a DNN that performs 10-class classification and is trained with 1000 pieces of teacher data per class and 100 epochs as the number of times of training. Furthermore, the inspector model (for summer) is a detector using the DNN that performs 10-class classification and is trained with 200 pieces of teacher data per class acquired from June to August and 100 epochs as the number of times of training.

The inspector model (for autumn) is a detector using the DNN that performs 10-class classification and is trained with 200 pieces of teacher data per class acquired from September to November and 100 epochs as the number of times of training. The inspector model (for winter) is a detector using the DNN that performs 10-class classification and is trained with 200 pieces of teacher data per class acquired from December to February and 100 epochs as the number of times of training. The inspector model (for spring) is a detector using the DNN that performs 10-class classification and is trained with 200 pieces of teacher data per class acquired from March to May and 100 epochs as the number of times of training.

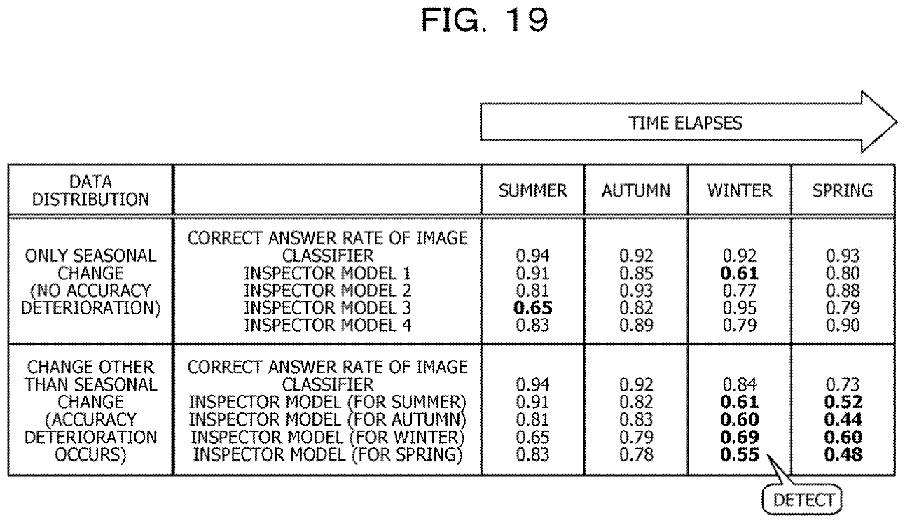

Under such conditions, image classification similar to that in the first embodiment is performed. When the inspector model corresponding to the season is used, a change in a matching rate in a case where only a seasonal change occurs in the input data is compared with a change in a matching rate in a case where a change other than the seasonal change occurs in the input data. FIG. 19 is a diagram for explaining the specific example of the second embodiment. FIG. 19 illustrates a detection results in which tendency of clothing changes according to the season.

As illustrated in FIG. 19, in a case of only the seasonal change, the matching rates of all the inspector models in the respective seasons do not fall below the threshold at the same time, and erroneous detection can be prevented. On the other hand, in a case of the change other than the seasonal change, the matching rates of all the inspector models for the winter input data fall below the threshold at the same time, accuracy deterioration can be correctly detected. Therefore, the accuracy deterioration detection device 50 can prevent erroneous detection in the data, of which the distribution periodically changes, such as the seasonal data.

### Third Embodiment

By the way, in the second embodiment, an example has been described where, when the cycle is already known such as seasons, the data in each cycle is extracted and the inspector model corresponding to each cycle is generated. However, the cycle of the data can be specified using the method according to the first embodiment.

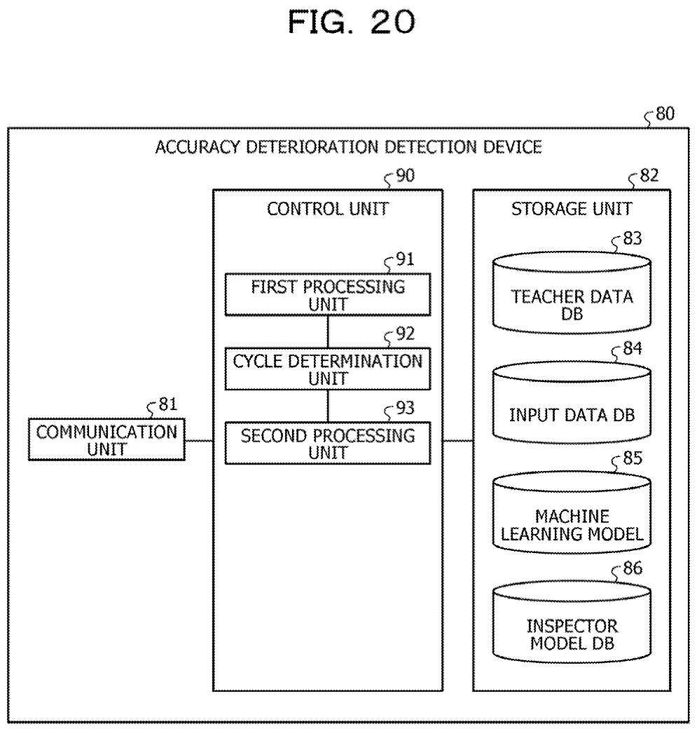

FIG. 20 is a functional block diagram illustrating a functional structure of an accuracy deterioration detection device 80 according to a third embodiment. As illustrated in FIG. 20, the accuracy deterioration detection device 80 includes a communication unit 81, a storage unit 82, and a control unit 90.

The communication unit 81 is a processing unit that controls communication with another device and is, for example, a communication interface or the like. For example, the communication unit 81 receives various instructions from an administrator's terminal or the like. Furthermore, the communication unit 81 receives input data to be determined (predicted) from various terminals.

The storage unit 82 is an example of a storage device that stores data and a program or the like executed by the control unit 90, and is, for example, a memory, a hard disk, or the like. The storage unit 82 stores a teacher data DB 83, an input data DB 84, a machine learning model 85, and an inspector model DB 86. Note that, because the teacher data DB 83, the input data DB 84, the machine learning model 85, and the inspector model DB 86 have similar structures to those of the teacher data DB 13, the input data DB 14, the machine learning model 15, and the inspector model DB 16 described with reference to FIG. 4, detailed description will be omitted.

The control unit 90 is a processing unit that controls the entire accuracy deterioration detection device 80 and is, for example, a processor or the like. The control unit 90 includes a first processing unit 91, a cycle determination unit 92, and a second processing unit 93. Note that the first processing unit 91, the cycle determination unit 92, and the second processing unit 93 are examples of an electronic circuit included in a processor, examples of a process executed by a processor, or the like.

Here, the first processing unit 91 executes functions similar to those of the inspector model generation unit 21, the setting unit 22, the deterioration detection unit 23, the display control unit 26, and the notification unit 27 described in the first embodiment. Furthermore, the second processing unit 93 executes functions similar to those of the cycle specification unit 61, the inspector model generation unit 62, the setting unit 63, the deterioration detection unit 64, and the notification unit 65 described in the second embodiment.

A difference from the first and the second embodiments is a point that the cycle determination unit 92 specifies a cycle of input data on the basis of a result of the first processing unit 91 and notifies the second processing unit 93 of the cycle and the second processing unit 93 relearns each inspector model using the notified cycle.

For example, the cycle determination unit 92 refers to real-time display of an accuracy state every hour displayed by the first processing unit 91. Then, when detecting that there is no state where all the inspector models are less than a threshold at the same time, the cycle determination unit 92 determines that the input data has a cycle.

Then, the cycle determination unit 92 specifies that accuracy of an inspector model 1 is the highest between 7 o'clock and 10 o'clock, accuracy of an inspector model 2 is the highest between 11 o'clock and 14 o'clock, accuracy of an inspector model 3 is the highest between 15 o'clock and 18 o'clock, and accuracy of an inspector model 4 is the highest between 19 o'clock and 6 o'clock.

In this case, the cycle determination unit 92 specifies that a cycle 1: 7 o'clock to 10 o'clock, a cycle 2: 11 o'clock to 14 o'clock, a cycle 3: 15 o'clock to 18 o'clock, and a cycle 4: 19 o'clock to 6 o'clock and notifies the second processing unit 93 of the specified cycles.

The second processing unit 93 that has received this notification divides teacher data into the four cycles described above based on an imaging time and extracts the teacher data. Then, the second processing unit 93 relearns the inspector model 1 using teacher data in the cycle 1, relearns the inspector model 2 using teacher data in the cycle 2, relearns the inspector model 3 using teacher data in the cycle 3, and relearns the inspector model 4 using teacher data in the cycle 4. In this way, it is possible to automatically specify a cycle and generate an inspector model corresponding to each cycle.

Note that, when the number of inspector models existing from the beginning does not match the number of cycles and the number of inspector models is larger, any one of the inspector models is not used, and when the number of cycles is larger, a new inspector model is generated. Furthermore, the teacher data to be relearned may be data that is used for learning once or data that is newly collected, or the input data determined by the machine learning model 15 may be used. Furthermore, because the determined input data is unlabeled data, the determination result of the machine learning model 15 can be attached as a label.

### Fourth Embodiment

Incidentally, while the embodiments of the present disclosure have been described above, the present disclosure may be carried out in a variety of different modes in addition to the embodiments described above.

[Numerical Values, etc.]

Furthermore, the data example, the numerical values, each threshold, the feature amount space, the number of labels, the number of inspector models, the specific example, the cycle, or the like used in the embodiments described above are merely examples and can be arbitrarily changed. Furthermore, the input data, the learning method, or the like are merely examples and can be arbitrarily changed. Furthermore, as the learning model, various methods such as a neural network can be adopted.

[Matching Rate]

For example, in the embodiments described above, an example has been described in which the matching rate of the input data belonging to the model applicability domain of each class is obtained. However, the embodiment is not limited to this. For example, accuracy deterioration can be detected according to the matching rate of the output result of the machine learning model 15 and the output result of the inspector model.

Furthermore, in the example in FIG. 7, although the matching rate is calculated as focusing on the class 0, it is possible to focus on each class. For example, in the example in FIG. 7, after the time elapses, the monitoring unit 25 acquires that six pieces of input data belongs to the model applicability domain of the class 0, six pieces of input data belongs to the model applicability domain of the class 1, and eight pieces of input data belongs to the model applicability domain of the class 2 from the machine learning model 15 to be monitored. On the other hand, the monitoring unit 25 acquires that three piece of input data belongs to the model applicability domain of the class 0, nine pieces of input data belongs to the model applicability domain of the class 1, and eight pieces of input data belongs to the model applicability domain of the class 2 from the inspector model. In this case, the monitoring unit 25 can detect the decrease in the matching rate for each of the class 0 and the class 1.

[Relearning]

Furthermore, when accuracy deterioration is detected, each accuracy deterioration detection device can relearn the machine learning model 15 using the determination result of the inspector model as the correct answer information. For example, each accuracy deterioration detection device can generate relearning data using each input data as an explanatory variable and a determination result of the inspector model for each input data as an objective variable and relearn the machine learning model 15. Note that, in a case of the plurality of inspector models, an inspector model having a low matching rate with the machine learning model 15 can be adopted.

[System]

Pieces of information including a processing procedure, a control procedure, a specific name, various types of data, and parameters described above or illustrated in the drawings may be optionally changed unless otherwise specified.

Furthermore, each component of each device illustrated in the drawings is functionally conceptual and does not necessarily have to be physically configured as illustrated in the drawings. In other words, for example, specific forms of distribution and integration of each device are not limited to those illustrated in the drawings. That is, for example, all or a part of the devices may be configured by being functionally or physically distributed or integrated in optional units depending on various types of loads, usage situations, or the like. For example, a device that executes the machine learning model 15 and classifies (determine) the input data and a device that detects accuracy deterioration can be implemented as different housings.

Moreover, all or any part of individual processing functions performed by each device may be implemented by a central processing unit (CPU) and a program analyzed and executed by the CPU or may be implemented as hardware by wired logic.

[Hardware]

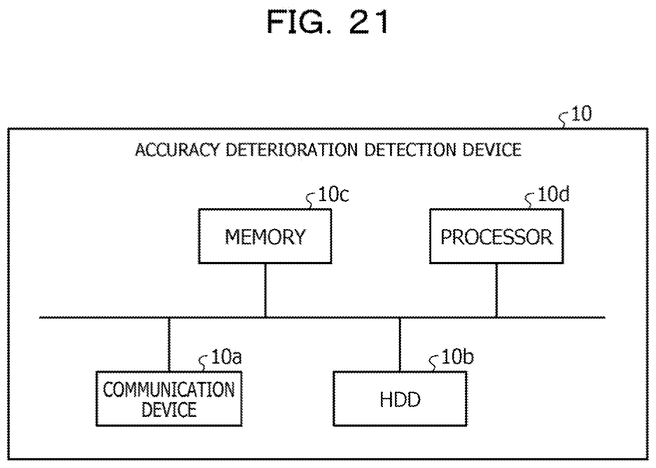

FIG. 21 is a diagram for explaining a hardware structure example. Here, the accuracy deterioration detection device 10 according to the first embodiment will be described as an example. However, the accuracy deterioration detection devices of the other embodiments have a similar hardware configuration. As illustrated in FIG. 21, the accuracy deterioration detection device 10 includes a communication device 10a, a hard disk drive (HDD) 10b, a memory 10c, and a processor 10d. Furthermore, the respective units illustrated in FIG. 21 are mutually connected by a bus or the like.

The communication device 10a is a network interface card or the like and communicates with another device. The HDD 10b stores a program that operates the functions illustrated in FIG. 4, and a DB.

The processor 10d reads a program that executes processing similar to the processing of each processing unit illustrated in FIG. 4 from the HDD 10b or the like, and develops the read program in the memory 10c, thereby operating a process that executes each function described with reference to FIG. 4 or the like. For example, this process executes a function similar to the function of each processing unit included in the accuracy deterioration detection device 10. Specifically, for example, the processor 10d reads a program having functions similar to those of the inspector model generation unit 21, the setting unit 22, the deterioration detection unit 23, the display control unit 26, the notification unit 27, or the like from the HDD 10b or the like. Then, the processor 10d executes a process for executing processing similar to those of the inspector model generation unit 21, the setting unit 22, the deterioration detection unit 23, the display control unit 26, the notification unit 27, or the like.

As described above, the accuracy deterioration detection device 10 operates as an information processing device that performs an accuracy deterioration detection method by reading and executing the program. Furthermore, the accuracy deterioration detection device 10 may also implement functions similar to the functions of the above-described embodiments by reading the program described above from a recording medium by a medium reading device and executing the read program described above. Note that a program referred to in other embodiments is not limited to being executed by the accuracy deterioration detection device 10. For example, the embodiment may be similarly applied to a case where another computer or server executes the program, or a case where these computer and server cooperatively execute the program.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A generation method performed by a computer, the generation method comprising:
classifying a plurality of pieces of teacher data into each cycle according to a condition that is preset; and
generating each detection model, which corresponds to each cycle, that detects a change in an output result of a machine learning model for each cycle by using teacher data that belongs to each cycle.

2. The generation method according to claim 1, wherein
the generating includes generating each of the detection models that have different model applicability domains that specify a range of a label to be output for input data through machine learning with first teacher data, of which the number of pieces is less than second teacher data used to learn the machine learning model, which corresponds to each cycle when each detection model that corresponds to each cycle is generated.

3. The generation method according to claim 1, wherein
the classifying incudes classifying the plurality of pieces of teacher data for each season when each of the plurality of pieces of teacher data is collected, and
the generating includes generating each of the detection models that corresponds to each of the seasons through supervised learning based on teacher data that belongs to each of the seasons.

4. The generation method according to claim 1, wherein
the classifying includes classifying the plurality of pieces of teacher data for each time period when each of the plurality of pieces of the teacher data is collected, and
the generating includes generating each of detection models that corresponds to each of the time periods through supervised learning based on teacher data that belongs to each of the time periods.

5. A non-transitory computer-readable storage medium storing a generation program that causes a processor included in a computer to execute a process, the process comprising:
classifying a plurality of pieces of teacher data into each cycle according to a condition that is preset; and
generating each detection model, which corresponds to each cycle, that detects a change in an output result of a machine learning model for each cycle by using teacher data that belongs to each cycle.

6. An information processing apparats comprising:
a memory; and
a processor coupled to the memory and configured to:
classify a plurality of pieces of teacher data into each cycle according to a condition that is preset, and
generate each detection model, which corresponds to each cycle, that detects a change in an output result of a machine learning model for each cycle by using teacher data that belongs to each cycle.
